(19) United States
(12) Patent Application Publication
(10) Pub. No.: US 2010/0083849 A1
(43) Pub. Date: Apr. 8, 2010

(54) BARREL BAR AND BARREL SEGMENT

(75) Inventors: Robert J. Williams, Painesville, OH (US); Maurice A. Williams, Brook Park, OH (US)

Correspondence Address: CALFEE HALTER & GRISWOLD, LLP, 800 SUPERIOR AVENUE, SUITE 1400, CLEVELAND, OH, 44114, US

(73) Assignee: Anderson International Corp

(21) Appl. No.: 12/516,603

(22) PCT Filed: Dec. 7, 2006
(86) PCT No.: PCT/US06/46727

§ 371 Date: May 28, 2009

(51) Int. Cl. B30B 9/14; B30B 15/04

(52) U.S. Cl. 100/127; 100/110; 100/117; 100/126; 100/145

(57) ABSTRACT

A barrel bar, for use in a barrel of a screw device having a screw rotatable in the barrel about an axis, has a generally trapezoidal cross-sectional configuration. The barrel bar may have arcuate inner and outer surfaces and a relief along one side surface.

### BACKGROUND OF THE INVENTION

Screw devices, such as continuous screw presses, are used in processing oilseeds and other materials. Such a device has a rotating screw or worm assembly to move material down a barrel while compacting the material. A choke at the downstream end of the barrel helps to control the pressure on the material.

Upstream of the choke is a discharge section of the press, with openings to allow oil, water, or other liquids, pressed from the material, to be discharged from the barrel. The discharge section is typically made from a plurality of axially extending barrel bars held together by barrel rings to form a barrel cage. The barrel rings are in two parts, i.e., semicircular halves, bolted together to form the barrel ring. At the portions of the barrel cage that are located between the barrel rings, oil can flow radially out of the barrel through small, axially extending gaps between adjacent barrel bars. At the portions of the barrel cage that are located at the barrel rings, oil can not flow out of the barrel because there are spacers that fill the gaps between adjacent barrel bars; the spacers and the barrel rings block the flow.

For almost 100 years, barrel cages in continuous screw presses have been made from an assembly of barrel bars, spacers, barrel rings with ring shims, knife bars or keeper knife bars, keeper bars, frame bars, pressure bars, filler bars, “M” strips, etc. The assembly is firmly clamped onto the screw press using clamping bars and clamping bolts. The pressure exerted by the clamping bolts holds the individual parts firmly in position.

Prior art barrel bars are typically made with a rectangular cross section and with bevels on one edge (top and bottom of the same face if the bars are meant to be reversible). The bevels are made to line up with the radii of the barrel's cross section so that the bevels help align the bars so that the flat tops are perpendicular with barrel's centerline. The two bottom edges of each barrel bar rest on the barrel rings (or ring shims, if they are used). The spacers have three legs that make them free standing and also help align the bars when the barrels are assembled.

Persons assembling the barrel cages must measure the “A” gap between barrel ring halves to ensure that, when the clamping bolts clamp the barrel ring halves together, they do not come into contact with each other. This insures that all the force exerted by the clamping bolts is transferred onto the barrel bars and spacers, so that they are held as tightly as possible. This is typically done by clamping everything together tightly, measuring the gap, then loosening the assembly and removing or inserting shims or spacers and retightening the assembly. The gap is then re-measured, in a trial and error process. These procedures can require considerable time and skill at assembly, and doesn't always work well.

A key bar/gib bar arrangement, that avoids the requirement to test for the gap between barrel ring halves, removes the need to loosen the barrel bars and adjust the number of spacers used. While such an assembly requires less skill and is considerably less labor intensive, in some cases a key bar/gib bar assembly does not hold traditional rectangular-shaped barrel bars firmly enough in place so that they do not shift position under the high dynamic pressure and stress exerted by the rotating shaft against the material when the screw press is operating.

### BRIEF DESCRIPTION OF THE DRAWINGS

FIG. 1 is a longitudinal side view of a screw device in the form of a screw press that is a first embodiment of the invention;

FIG. 2A is a view of a portion of a prior art barrel bar and spacer;

FIG. 2B is a view of a portion of a barrel bar and spacer of the present invention;

FIG. 3 is a sectional view of a barrel assembly of the screw device of FIG. 1;

FIG. 4 is a view taken along line 4-4 of FIG. 3;

FIG. 5 is a view taken along line 5-5 of FIG. 3;

FIG. 6 is a side elevational view of a barrel bar of the present invention;

FIG. 7 is a sectional view taken along line 7-7 of FIG. 6; and

FIG. 8 is a sectional view taken along line 8-8 of FIG. 6.

### DETAILED DESCRIPTION

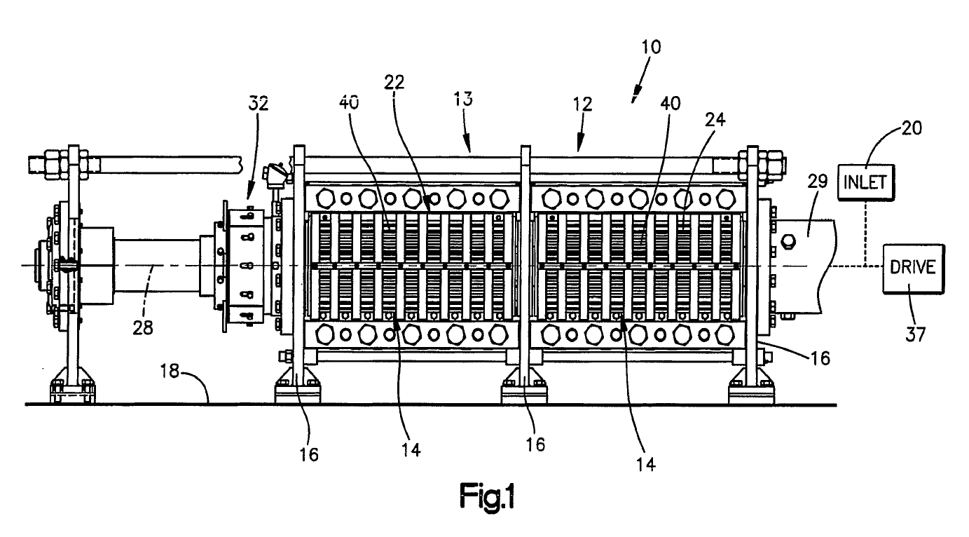

FIG. 1 shows a screw device 10 in accordance with a first embodiment of the present invention. The screw device 10 is a screw press, although the invention is applicable to other screw devices. The screw device 10 includes a barrel structure 12 having an elongate, generally cylindrical configuration. The barrel structure 12 includes a barrel assembly 13 comprising multiple barrel segments 14 (FIG. 2) supported in-line by frames 16 anchored to a base or floor 18. The barrel structure 12 includes an entry or inlet portion 20 (shown schematically in FIG. 1) at an upstream location (located to the right in FIGS. 1-4) on the screw device 10.

The screw device 10 has a drainage portion 22 (FIG. 1) to allow oil that is liberated from the material by compacting to flow out of the barrel wall 24. The drainage portion 22 includes the individual barrels 14.

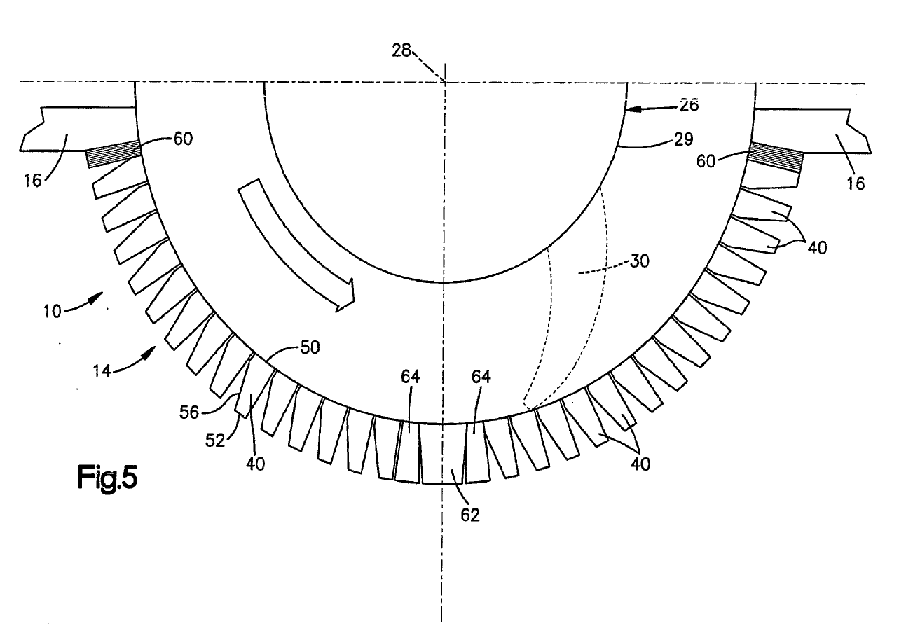

Within the barrel structure 12 is a screw or worm assembly (shown schematically at 26 in FIG. 5) that is rotatable about a central longitudinal axis 28. The worm assembly 26 includes a shaft 29 and a plurality of screw or worm elements 30 mounted on the shaft for rotation therewith. The worm elements 30 are positioned along the length of the shaft 29 from the inlet portion 20 to a discharge portion 32 located at a downstream (to the left as viewed in FIG. 1) location on the screw device 10.

A drive mechanism 37 (shown schematically in FIG. 1), for example a motor, rotates the shaft 29. The inlet portion 20 allows product or material to be placed within the barrel 12 of the screw device 10. As the shaft 29 rotates, the worm assembly 26 moves the material in a downstream direction in the barrel 12. As the material is moved downstream, the worm assembly 26 removes oil from the material by compacting the material. The removed oil drains out through the drainage portion 22 of the barrel 12.

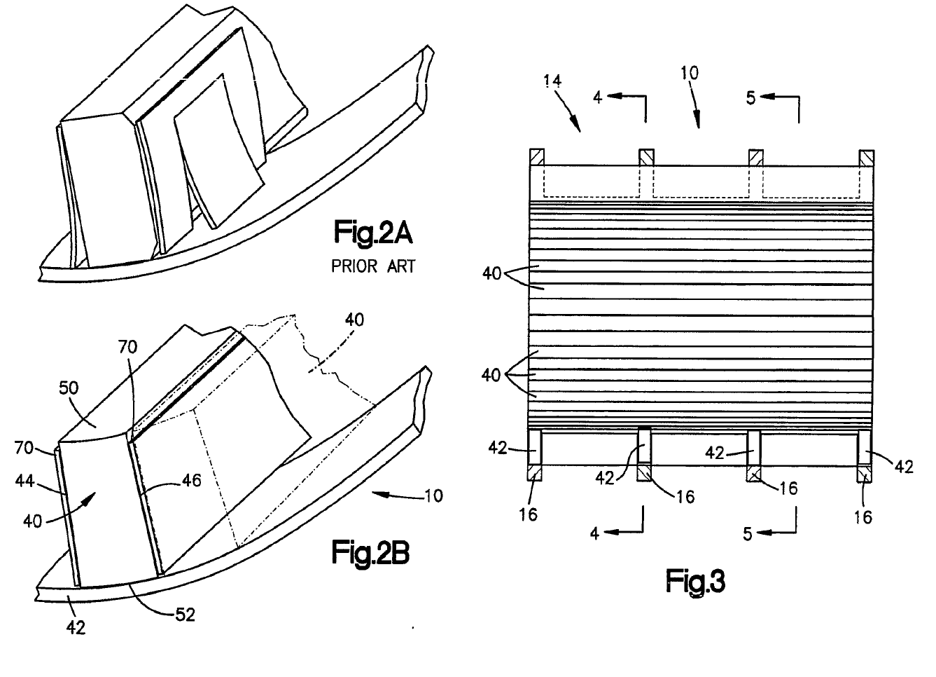

Each barrel segment 14 (FIGS. 1 and 3) includes a plurality of barrel bars 40. Each barrel bar 40 is an elongate member, typically made of steel but possibly made from another material, such as plastic or ceramic. The barrel bars of a barrel assembly are preferably, but need not be, identical to each other.

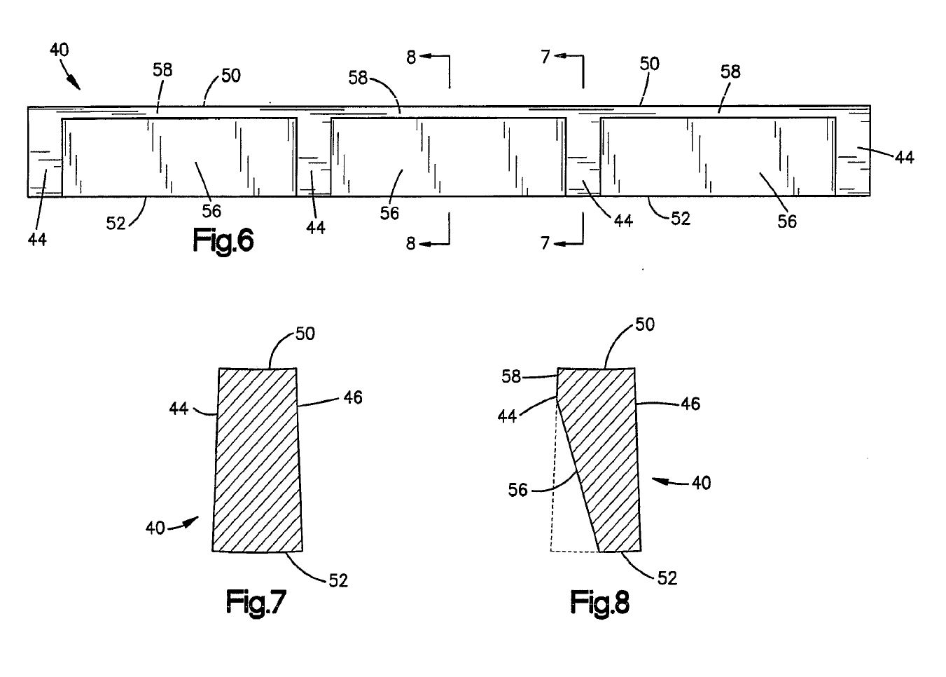

The barrel bar 40 has a first cross-sectional configuration, as illustrated in FIG. 7 and described below, at those locations along its length where it is engaged by a barrel ring 42. The barrel bar 40 has a second cross-sectional configuration, as illustrated in FIG. 8 and described below, different from the first cross-sectional configuration, at those locations along its length where it is not engaged by a barrel ring 42—that is between the spaced locations of the barrel rings, where the drainage occurs.

The first cross-sectional configuration of the barrel bar 40 (FIG. 7) provides a generally trapezoidal configuration for the barrel bar. The bar 40 has non-parallel, planar first and second side surfaces 44 and 46. The side surfaces 44 and 46 extend in planes that are radial with respect to the axis 28 of the cylinder, when the barrel bar 40 is assembled in the screw device 10. The first and second side surfaces 44 and 46 are thus closer together at their radially inward ends, and farther apart at their radially outward ends.

The bar 40 has an inner surface 50 formed as an arc of a cylinder centered on the axis 28. The radius of curvature of the inner surface 50 of the barrel bar 40 matches the inner diameter of the barrel 14.

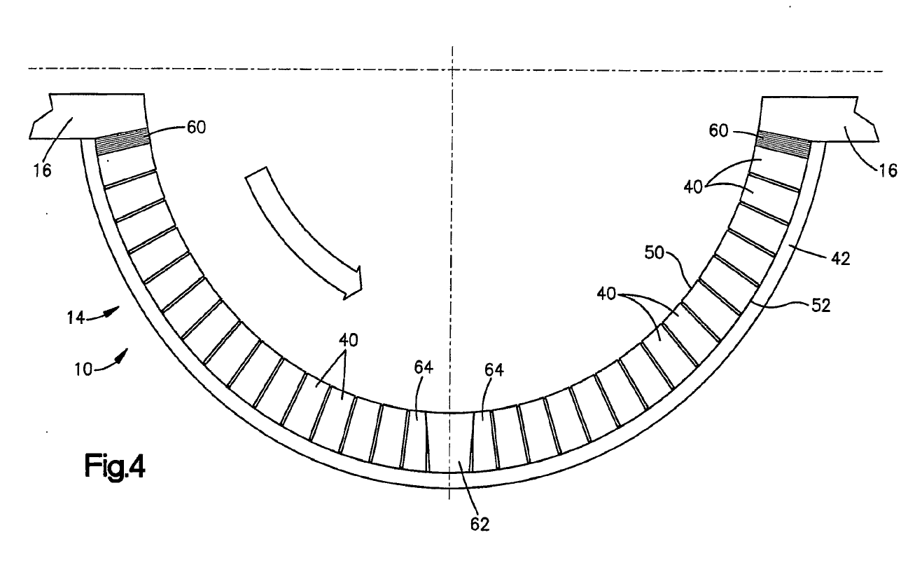

The bar 40 has an outer surface 52 formed as an arc of a cylinder centered on the axis 28. The outer surface 52 matches the radius of curvature of the inner surface of the barrel ring 42 (FIG. 4). As a result, substantially all if not all the outer surface 52 of the barrel bar 40 lies in surface contact with the inner surface of the barrel ring 42 when the barrel bar 40 is assembled in the screw device 10. In other embodiments, both the inner surface 50 and outer surface 52 of the barrel bar 40 need not be arcuate.

The second cross-sectional configuration of the barrel bar 40 (illustrated in FIG. 8) is at least partially similar to the first cross-sectional configuration and provides a generally trapezoidal cross-sectional configuration for the barrel bar. Thus, the second cross-sectional configuration includes the non-parallel, planar first and second side surfaces 44 and 46. The side surfaces 44 and 46 extend in radial planes with respect to the axis 28 of the cylinder, when the barrel bar 40 is fully assembled in the screw device 10.

In the second cross-sectional configuration, the bar 40 has an inner surface 50 formed as an arc of a cylinder centered on the axis 28. The bar 40 has an outer surface 52 formed as an arc of a cylinder centered on the axis 28. The outer surface 52 has substantially the same radius of curvature as the inner surface of the barrel ring 42.

The bar 40 is relieved along the first side surface 44. The resulting relief surface 56 extends from a location on the first side surface 44 radially outward of the bar's inner surface 50, up to the outer end surface 52. The relief surface 56 extends at an angle to the first surface 44 and to the radius of the device.

The remaining portion of the first side surface 44, which is radially inward of the relief surface, forms a land 58. Because of the presence of the land 58, as the bar 40 wears from inside out, which is inevitable, the size of the gap between the bar 40 and an adjacent bar remains constant, and does not increase as it would if the relief surface 56 extended the full radial extent of the bar.

FIG. 6 is a side elevational view of the bar 40. This view shows the first side surface 44; the relief areas 56; and the lands 58. This view also shows that the first side surface 44 is not relieved at the locations of the barrel rings 42.

The barrel bars 40 are assembled into the barrel segment 14 as shown in FIGS. 4 and 5. This assembly may be done in a known manner, for example, using barrel rings, clamp bolts, etc. Typically one or more M strips are used at the circumferential end of each barrel half segment, as shown for example at 60 in FIGS. 4 and 5, to set the final spacing of the assembly.

This assembly may be done with a knife bar and pressure bar setup. This assembly may alternatively be done with a key bar 62 and gib bar 64 setup as illustrated in FIGS. 4 and 5. With such an arrangement, nuts on studs (not shown) pull the key bar 62 down between the two gib bars 64, spreading the components sideways (circumferentially outward, away from each other) to apply pressure to squeeze the barrel bars etc. against rigidly attached frame bars 16 at each end of the barrel half.

At the location of the barrel rings 42, flat spacers 70 (FIG. 2B) are provided between adjacent barrel bars 40. The flat spacers 70 are simpler and less expensive than the three-legged spacers of the typical prior art barrel assembly shown in FIG. 2A. The use of the spacers 70, together with the fact that at the locations of the barrel rings 42 the bars 40 are not relieved, provides a solid wall that blocks flow of liquid (such as oil) or solids out of the barrel at those locations.

In between the locations of the barrel rings 42, along the lengths of the barrel bars 40, no spacers are used. The lack of spacers provides openings between the adjacent barrel bars 40 that enables flow of liquid (such as oil) or solids out of the barrel at those locations. The material flows through the small gap between the land 58 of one barrel bar 40 and the adjacent second side surface 46 of an adjacent barrel bar. The material then flows through the gap between the relief surface 56 and the second side surface 46 of the adjacent barrel bar 40. This gap grows larger as it extends radially outward. This promotes the flow of material out of the barrel without getting caught or stuck on the barrel bars 40.

Because the barrel bar outer surfaces 52 are rounded to match the curvature of the barrel ring 42, there is area contact between the parts, not just line contact. Therefore, it is much less likely that the barrel bars 40 can shift out of position relative to the barrel ring 42. Because the sides 44 and 46 of the bars 40 line up with the radii of the barrel, there is no extra space between the barrel bar sides at the bottoms as well as at the tops. The drainage gap is determined solely by the spacers 70, which are single piece to insure greater ease of assembly.

The curved inner surfaces 50 of the individual barrel bars 40 makes the assembly of bars provide a circular surface facing the worm fighting 30. A circular surface insures uniform clearance between any point on any bar 40 and the outside surface of the worm fighting 30. In contrast, bars with flat tops (such as rectangular bars) present a greater clearance at the edges, where the drainage slots are, than at the midpoint of the bars. This added clearance potentially enables a thicker layer of solids to accumulate where drainage is expected, a layer that could impede the desired drainage. When there are no drainage slots near to the key bar/gib bars, as in the illustrated embodiment, those bars can have flat tops and flat bottoms, but in order to maintain the circular inside dimension of the barrel, it may be preferred to make them with curved tops and bottoms also.

The present barrel bar configuration permits, when the key bar 62 is pulled down tight, that all side and bottom surfaces of every barrel bar 40, every spacer 70, and every “M” strip 60 touch each other at the location of every barrel ring 42 (where the barrel ring prevents drainage and where support for the barrel bars is required and provided). Therefore, the pressure exerted by the key bar 62 is sufficient to hold all the barrel bars 40 properly aligned, without shifting, during the high shear/pressure conditions when the screw press 10 is operating. The barrel cages 14 only have to be assembled once, without measurement of the barrel ring gap, which can provide a considerable savings in labor and required skill and which can provide for better press operation.

The barrel bars 40 of the present invention are also usable, and advantageous, without a key bar and gib bar setup. In such a case, the assembler would still have to be concerned with setting the “A” gap, but the press 10 would have the benefit of barrel bars 40 that do not shift out of position during operation.

Because of the trapezoidal configuration (as opposed to the bevel-on-rectangle prior art configuration shown in FIG. 2A), the direction of rotation of the screw, as shown by the arrow in FIG. 5, is not relevant.

Between the barrel rings 42, the relief 56 on the barrel bars 40 permits unobstructed flow of oil and fines (solids that come out with the oil). One set of exemplary (not limiting) dimensions provides a bar thickness (circumferentially) of ½″ on top, relieved on one side so that the bottoms are ¼″ thick. This amount of relief permits easy flow of oil and of whatever solids come out with the oil. The radial length of the lands 58 may be, as one example, one eighth of an inch, although a suitable range could be any length greater than 1/64″ and less than ½″ would suffice.

From the above description of the invention, those skilled in the art will perceive improvements, changes, and modifications in the invention. For example, it is contemplated that complete presses can be sold with barrel bars of the invention, as well as barrel assemblies, and individual barrel bars. Such improvements, changes, and modifications within the skill of the art are intended to be included within the scope of the appended claims.

Having described the invention, I claim:

1. A barrel bar for use in a barrel of a screw device having a screw rotatable in the barrel about an axis;
the barrel bar having a generally trapezoidal cross-sectional configuration.

2. A barrel bar as set forth in claim 1 having non-parallel, opposite, first and second side surfaces that are disposed so as to extend in radial planes of a screw device when the barrel bars are assembled in a barrel of a screw device.

3. A barrel bar as set forth in claim 1 having concentric, arcuate inner and outer surfaces.

4. A barrel bar as set forth in claim 3 for use in a barrel of a screw device that includes a plurality of barrel rings, wherein the inner surface of the barrel bar has a radius of curvature that matches the inner diameter of the barrel, and the outer surface of the barrel bar has a radius of curvature that matches the inner diameter of the barrel rings.

5. A barrel bar as set forth in claim 4 wherein a first side surface of the barrel bar is at least partially relieved to provide a gap between adjacent barrel bars.

6. A barrel bar as set forth in claim 5 wherein the relief is provided by a relief surface that extends from a location on the first side surface radially outward of the inner surface, to a location on the outer surface, at an angle to the first side surface.

7. A barrel bar for use in a cylindrical barrel of a screw device having a screw rotatable in the barrel about an axis, the screw and barrel being centered on the axis, the barrel being of the type made up of a plurality of axially extending barrel bars held together by a plurality of axially spaced barrel rings;
said barrel bar having a first portion for location at the axial position of the barrel rings and a second portion for location axially between the barrel rings, the first portion of the bar having a first cross-sectional configuration and the second portion of the bar having a second cross-sectional configuration that is different from the first cross-sectional configuration;
the first portion and the second portion of the bar each having a generally trapezoidal cross-sectional configuration with non-parallel, opposite, first and second side surfaces.

8. A barrel bar as set forth in claim 7 wherein the first and second side surfaces extend substantially radially when the bar is assembled in the barrel.

9. A barrel bar as set forth in claim 8, wherein the second portion of the bar has an arcuate inner surface centered on the axis.

10. A barrel bar as set forth in claim 8 wherein the second portion of the bar has an arcuate outer surface centered on the axis.

11. A barrel bar as set forth in claim 10 wherein the second portion of the bar has an arcuate inner surface centered on the axis.

12. A barrel bar as set forth in claim 11 wherein the inner surface has a radius of curvature that matches the inner diameter of the barrel and the outer surface has a radius of curvature that matches the inner diameter of the barrel rings.

13. A barrel bar as set forth in claim 7 wherein the first side surface of the second portion of the barrel bar is relieved along a radially outer portion.

14. A barrel bar as set forth in claim 13 wherein the relief is provided by a relief surface that extends from a location on the first side surface radially outward of the inner surface, to a location on the outer surface, at an angle to the first side surface.

15. A barrel segment for use as part of a cylindrical barrel of a screw device having a screw rotatable in the barrel about an axis, the screw and barrel being centered on the axis, said barrel segment comprising:
a plurality of axially extending barrel bars; and
a plurality of axially spaced barrel rings for clamping the barrel bars into a cylindrical configuration with bars adjacent to each other around the periphery of the barrel segment;
the barrel bars having a generally trapezoidal cross-sectional configuration with non-parallel, opposite, first and second side surfaces.

16. A barrel segment as set forth in claim 15 wherein at the location of the barrel rings, each of the barrel bars has a first cross-sectional configuration, and at areas axially between the barrel rings, each of the bars has a second cross-sectional configuration that is different from the first cross-sectional configuration.

17. A barrel segment as set forth in claim 16 wherein the second cross-sectional configuration of the barrel bar has non-parallel, opposite, first and second side surfaces, the first side surface being relieved along a radially outer portion.

18. A barrel segment as set forth in claim 17 wherein the relief is provided by a relief surface that extends from a location on the first side surface radially outward of an inner surface of the barrel bar, to a location on an outer surface of the barrel bar, at an angle to the first side surface and to the radius of the device.

19. A barrel segment as set forth in claim 18 wherein the inner surface of the barrel bar has an arcuate configuration centered on the axis.

20. A barrel segment as set forth in claim 18 wherein the outer surface of the barrel bar has an arcuate configuration centered on the axis.
